(19) United States
(12) Patent Application Publication
(10) Pub. No.: US 2007/0292821 A1
(43) Pub. Date: Dec. 20, 2007

(54) Dental Prostheses

(76) Inventor: Guy Marcel De Vreese, Sint-Martens-Latem (BE)

Correspondence Address: AMSTER, ROTHSTEIN & EBENSTEIN LLP, 90 PARK AVENUE, NEW YORK, NY, 10016, US

(21) Appl. No.: 11/661,218

(22) PCT Filed: Apr. 21, 2005
(86) PCT No.: PCT/EP05/04285

§ 371 Date: Feb. 26, 2007

(30) Foreign Application Priority Data
Aug. 25, 2004 (EP) 04447194.4

(51) Int. Cl. A61C 13/10

(52) U.S. Cl. 433/195; 29/896.1

(57) ABSTRACT

The present invention relates to a prosthetic assembly comprising two or more dental prostheses, wherein said prostheses are adjacently connected, and the assembly is pre-shaped to fit the teeth of a subject. It further relates to a dental appliance comprising one or more prosthetic assemblies and a trough wherein said trough corresponds to an improved dental arch. It also relates to methods for the manufacture of an appliance and a method of fitting an appliance. Furthermore, the present invention concerns temporary denture for surrounding a patient's teeth and gums.

### FIELD OF THE INVENTION

The present invention relates to dental prosthetic assemblies, dental appliances comprising one or more dental prostheses such as veneers or prosthetic dental assemblies, and to a process for their manufacture. It also relates to a method for positioning said dental prostheses on a patient's teeth using said dental appliances.

### BACKGROUND OF THE INVENTION

The surfaces of teeth sometimes become permanently stained, decayed or damaged. Several techniques have been developed to repair or improve the appearance and function of such teeth.

In a technique referred to as cosmetic bonding, a thin dental prosthesis such as a veneer or a facet having a shape and curvature matching the outline, shape and surface curvature of a tooth to be refaced is bonded to the front surface of the tooth. Each dental veneer is individually crafted and individually applied to the front surface of a tooth. The materials are specially selected to match the color and translucency of natural teeth. Dental prostheses such as veneers improve the cosmetic appearance of stained and/or damaged teeth, and are typically bound to the surface of teeth using an adhesive.

The common practice during bonding of a veneer to a tooth is for a dentist to hold the veneer in place during bonding with his or her finger. This is because as practiced now, the positioning and fitting of veneer normally entails the dentist holding onto the veneer with fingers of one hand, and then manipulating the veneer in the patient's mouth to position, fit and bind the veneer. Often, the positioning, fitting and bonding requires fingers of the other hand to be placed into the patient's mouth as well. This practice has several shortcomings. For example, a typical bonding process requires the use of a light probe to cure a light sensitive adhesive. However, the finger of the dentist obscures the veneer, and makes it difficult to both to see the veneer and to direct the light to the portion of the veneer that the dentist wants to cure.

Moreover, the dentist may need to reposition the veneer prior to curing the adhesive, and a single finger in a wet protective glove that may have sticky adhesive on one part and may be slippery on another part can have the tactile sensation impaired, slipping in relation to the veneer. Slipping can cause a failure in the bonding of the veneer, for example positioning the veneer incorrectly, compromising the integrity and aesthetics of the veneer. Margins that are not properly sealed can require the veneer to be removed by drilling away the veneer and adhesive from the surface of the tooth, causing patient discomfort, a prolonged procedure, and replacement by a new veneer.

Some dental appliances have been disclosed to replace a dentist's finger during this process. Instruments that can be used to pick-up and/or hold a veneer are known. For example U.S. Pat. No. 5,040,981 discloses a tool with a tip that has a tacky substance and, alternatively, thin tabs with adhesive for picking up, placing, and holding a veneer. U.S. Pat. Appl. No. US2003224321 discloses a tool having a handle, and on one end of the handle is a head having a plurality of grippers. Nevertheless, most dentists continue to use their fingers to pick up, place and hold the veneer in place during bonding, because known appliances do not apply pressure evenly over the surface of the veneer and do not give sufficient pressure feedback to the dentist.

This process of positioning, checking, and adjusting is done repeatedly until the veneer is fitted to the best of the dentist's abilities Patients often experience discomfort resulting from the introduction of multiple fingers into their mouth during the process of fitting a veneer.

There is a need for an effective, yet less cumbersome, method for positioning and fitting dental prostheses such as veneers on a patient's teeth.

It is an object of the present invention to provide a method and device for positioning and fitting simultaneously one or more dental prostheses on a patient's teeth. It is another object to provide a method and device for holding one or more dental prosthesis in proper registry with the teeth during the bonding process. It is a further is to provide a positioning method and device for positioning one or more dental prosthesis which is easily operable with a single hand. Another object of the invention is to provide a method and device for positioning one or more dental prostheses which is of a simple and inherently low-cost design.

### SUMMARY OF THE INVENTION

The present invention provides a prosthetic assembly comprising one or more dental prostheses, wherein said prostheses are adjacently connected, and the assembly is pre-shaped to fit the teeth of a subject. The assembly is suitable for simultaneously positioning and holding said prostheses in proper registration with the teeth during the bonding process. This greatly expedites the fitting procedure. It is simplified so it can be performed by a technician.

The present invention also provides for a method for manufacturing a dental appliance suitable for fitting one or more dental prostheses on a patient's teeth comprising the steps of: (a) obtaining data of a patient dental arch, (b) using said data, generating a computer simulation of an improved patient dental arch, wherein said patient dental arch is improved by incorporation thereon of one or more virtual dental prostheses, and (c) manufacturing a dental appliance corresponding to the improved patient dental arch, wherein said dental appliance comprises a trough provided with one or more dental prostheses.

The present invention also provides a method for fitting one or more dental prosthesis on a patient's teeth comprising the steps of:

(a) obtaining data of a patient dental arch,

(b) using said data, generating a computer simulation of an improved patient dental arch, wherein said patient dental arch is improved by incorporation thereon of one or more virtual dental prostheses,

(c) manufacturing a dental appliance corresponding to the improved patient dental arch, wherein said dental appliance comprises a trough provided with one or more dental prostheses,

(d) fitting said one or more dental prostheses by applying said dental appliance to the patient's dental arch,

e) bonding said one or more dental prostheses to the patient's teeth using conventional bonding techniques, and

(f) removing the trough from the patient dental arch.

In a preferred embodiment of the present invention, steps (b) and (c) of the present methods are performed using computer assisted design and manufacturing methods and equipments.

In an embodiment of the present invention, the data obtained from the patient dental arch are acquired by making a dental impression of the patient teeth and digitally scanning in 3D said dental impression. In another embodiment, the data obtained from the patient dental arch are acquired by photographing the patient teeth. In yet another embodiment, the data obtained from the patient dental arch are acquired by digitally scanning the patient teeth.

The present invention may additionally comprises the steps of applying dental bonding means to the surface of the patient teeth prior to positioning and fitting said dental prosthesis thereon.

Alternatively, said dental prostheses can be provided with dental bonding means. Suitable dental bonding means include but are not limited to dental adhesive and other conventional bonding means.

Suitable dental prostheses which can be used in the present method can be selected from the group comprising veneers, laminates, facings, facets and the like. Suitable material for manufacturing the dental prostheses for use in the present invention include but is not limited to ceramic, composite resins, customized pre-shaped laminates, porcelain/ceramic shells or plastic, and the like. In a preferred embodiment, the dental prostheses are veneers.

The present method permits to produce a dental appliance custom-made to fit the dental arch of a patient, wherein one or more dental prostheses or prosthetic assemblies are provided, suitable for simultaneously positioning and holding said prostheses in proper registration with the teeth during the bonding process. The present method enable one or more dental prostheses to be simultaneously positioned and fitted by simply fitting the custom-made dental appliance to the dental arch of the patient. This method greatly facilitates control and positioning of the dental prostheses on the patient's teeth.

The present invention also provides a dental appliance comprising a U shaped trough provided with one or more dental prostheses or prosthetic assemblies wherein said trough corresponds to an improved patient dental arch. Said dental appliance may be provided with one or more occlusal stops and/or anchoring points for alignment of trough-disposed prosthesis with the teeth of the patient. Said dental appliance may also be provided with a supporting substance disposed on the labile face or binding edge of the prosthesis. The trough of said dental appliance may be configured to leave a gingival edge exposed upon fitting, to allow visible window for fine alignment. Said exposed portion may be provided with a strip of releasable material to support the exposed part of the prostheses.

In an embodiment of the present invention said dental prostheses are provided with dental bonding means.

The dental appliance according to the present invention is particularly suited for simultaneously positioning and bonding one or more dental prostheses on the teeth of a patient. Said dental appliance is particularly suited for use in cosmetic bonding.

The dental appliances according to the invention permit a tight and a precise positioning of dental prostheses within the mouth of a patient while an adhesive bond is formed between the teeth and the prostheses. The dental appliances are custom—designed for a patient dental arch. The trough of said dental appliances has enough space to receive custom-made dental prostheses and to fit the dental arch of said patient.

The present invention provides therefore a new concept in esthetic dentistry which is particularly adapted to 3D designed veneers such as composite veneers. It is a non invasive cosmetic treatment. The present invention engenders low cost compared to other esthetic treatments. It provides immediate results. The present invention also provides the advantages that there are no anesthetics for the patient since no preparation is required.

The present invention will be further disclosed in detail hereunder wherein a preferred embodiment of the device of the present invention is disclosed in detail.

In the following detailed description, reference is made to the accompanying figure which form a part hereof, and in which is shown by way of illustration specific embodiments in which the invention may be practiced.

### BRIEF DESCRIPTION OF THE FIGURES

FIGS. 1 to 4 represents schematically in perspective views, steps in processes according to of the present invention.

FIGS. 5 to 8 represents schematic in perspective views prosthetic assemblies according to the present invention.

FIG. 9 represents a plan view of a set of a dental appliance according to the present invention, and a dental arch.

FIG. 10 represents a cross-sectional view of a set of a dental appliance according to the present invention.

FIG. 11 represents a front view of a set of a dental appliance according to the present invention, with and without removable strip.

FIG. 12 represents a schematic perspective view of a temporary denture for surrounding a patient's upper teeth and gums according to an embodiment of the present invention.

FIG. 13 represents a schematic perspective view of a temporary denture for surrounding a patient's upper front teeth and gums according to an embodiment of the present invention.

FIG. 14 represents a schematic perspective view of a temporary denture for surrounding a patient's lower teeth and gums according to an embodiment of the present invention.

FIG. 15 represents a schematic perspective view of a temporary denture for surrounding a patient's lower front teeth and gums according to an embodiment of the present invention.

### DETAILED DESCRIPTION

The present invention is directed to a dental appliance comprising 1, 2, 3, 4, 5, 6, 7, 8, 9, 10 or more dental prostheses or prosthetic assemblies and to a method for simultaneously positioning one or more dental prostheses using a dental appliance according to the invention. It also relates to a prosthetic assembly comprising 2, 3, 4, 5, 6, 7, 8, 9, 10, 11 or more custom-made prostheses. Although the dental prostheses for use in the present invention will be described hereunder in terms of veneers, the present invention also encompasses laminates, facings, facets and the like.

The articles “a” and “an” are used herein to refer to one or to more than one, i.e. to at least one, the grammatical object of the article. By way of example, “a dental appliance” means one dental appliance or more than one dental appliance.

As used herein the term “patient” refers to any mammal, preferably a human.

As used herein the term “dental arch” encompasses the teeth or the basal bone of either jaw or both the teeth and the basal bone or portion thereof. In preferred embodiment said dental arch encompasses the front teeth of the patient.

Prosthetic Assembly

The present invention relates to a set of dental prostheses which comprises two or more prostheses wherein the prostheses are adjacently connected to each other and the connected prostheses or assembly are pre-shaped to fit the teeth of a patient. Such assembly of pre-shaped dental prostheses is known herein as a prosthetic assembly or assembly. The number of prostheses in a prosthetic assembly may be more than 1, 2, 3, 4, 5, 6, 7, 8, 9, or 10. The connection is preferably located at and preferably restricted to the edges between the adjoining prostheses. The connection is preferably rigid. The connection is preferably of the same material as the prostheses. The connection can be removed such that the adjoining prostheses are not damaged or broken upon removal. Removing the connection between the prostheses can cleanly provide individual prostheses in a near finished state. According to a preferred aspect of the invention, a removable connection is achieved using a weakened portion of prostheses material (e.g. a thinner veneer material, a non-continuous veneer material, a stress fractured veneer material, or a combination of these), in which case the connection is removed by breaking. According to an aspect of the invention, the number of connections in a prosthesis is at least 2, 3, 4, 5, 6, 7, 8, 9, 10, 11, 12, 13, 14, or 15. According to an aspect of the invention, all adjacent prostheses are connected.

The inventors have found that prostheses already connected to match the teeth of the patient permits a rapid and accurate attachment of the prosthetic assembly. There is no requirement to align individual prostheses, only the single set. When the connections are made of the same material as the prostheses in a weakened form, the prosthetic assembly is easily manufactured from a single block of prostheses material or a single mould. This greatly reduces the cost of manufacture and expedites the production process. Once a prosthetic assembly is attached and bonded to the teeth of a patient, the connections are removed. Where the connections are made of the same material as the prostheses, the connections can be removed by tapping and shattering them. This simplifies the process as very steps or few tools are needed to form individual prostheses.

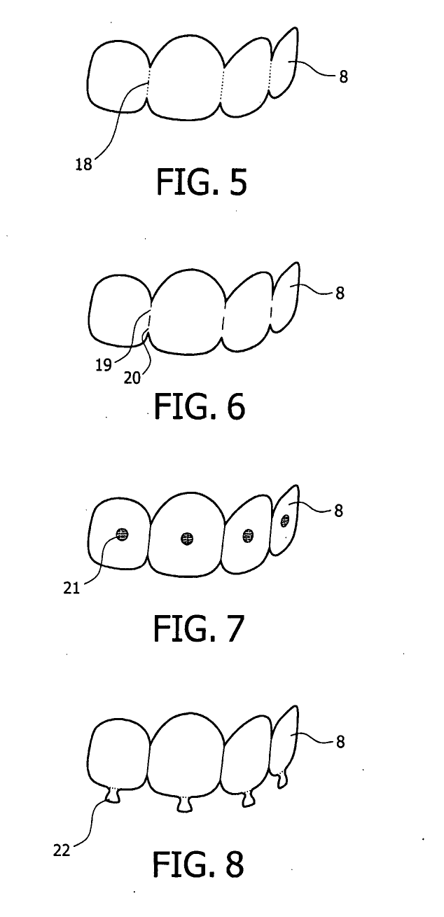

FIG. 5 shows in an embodiment of a prosthetic assembly 8 being connected in a continuous way through a connection 18 made of the same material as the veneer. FIG. 6 shows in an embodiment of a prosthetic assembly 8 being connected in a non continuous manner through two connecting points 19, 20.

In view of the few steps and ease of fitting, the custom-made prosthetic assembly may be fitted to a patient by a non-dental expert such as a dental technician.

According to another aspect of the present invention, a prosthesis as described herein further comprises a positioning means. The position means can be a ridge, pin, tab or any addition to the prosthesis by which the prosthesis can be positioned. The positioning means can be removed such that the prosthesis is not damaged or broken when the positioning means is removed. Preferably the positioning means is formed from the same material as the prosthesis. Preferably the positioning means is joined to the prosthesis using a weakened form of the prosthesis (e.g. by using a connection that is thinner, a non-continuous connection, stress fractured connection etc). Preferably the positioning means is situated on the biting edge or exposed face (i.e. face exposed after fitting) of the prosthesis. Where a prosthesis is part of a prosthetic assembly, a positioning means may be provided on one, more than 1, 2, 3, 4, 5, 6, 7, 8, 10 or 10 or more veneers, or on each prosthesis. FIG. 7 presents in one embodiment a prosthetic assembly 8, provided with positioning point (pin) 21 on the exposed face of each veneer. The positioning point can be made of the same material as the veneers. Said positioning point 21 can be removed through sand-blasting for example, once the veneers placed on the teeth to be restored. FIG. 8 presents in one embodiment a prosthetic assembly 8 with positioning point 22 on the biting edge of each veneer. The positioning point can be made of the same material as the veneers. Said point 22 can be removed through sand-blasting or snapping off, for example, once the veneers are bonded to the teeth to be restored.

Suitable materials for a prosthetic assembly and prostheses of the present invention include but are not limited to ceramic, composite resins, customized pre-shaped laminates, porcelain/ceramic shells or plastic, and the like. Non-limiting examples of ceramic materials suitable for manufacturing said prostheses include high strength ceramic materials such as alumina; zirconia, silicon nitride, silicon carbide, silica-alumina-nitrides, mullite, various garnets etc. and porcelain materials such as commercially available OPC® 3G™ porcelain and OPC® porcelain, both available from Jeneric/Pentron Inc., Wallingford, Conn., and commercially available Empress™ porcelain and Empress II™ porcelain, both available from Ivoclar North America, Amherst, N.Y.

Non-limiting examples of composite materials suitable for manufacturing said prosthetic assembly and prostheses include those materials such as those set forth in U.S. Pat. Nos. 4,717,341, 4,894,012, U.S. Pat. No. 6,200,136, U.S. Pat. No. 6,186,790 all of which are incorporated by reference herein. The composite material may be any known composite material such as a resin or polymeric material combined with particulate and/or fiber material or mixtures thereof. Preferably, the composite is a polymeric material having particulate therein such as commercially available Sculpture® composite available from Jeneric/Pentron Inc., Wallingford, Conn., or polymeric material reinforced with fiber and/or particulate such as commercially available FibreKor®) composite from Jeneric/Pentron, Inc., Wallingford, Conn.

The natural appearance of the original natural teeth is copied as closely as possible. The appearance of the original teeth is composed from a number of properties, such as color, translucency, lightness of the colors, brightness, etc which is carefully reproduced when manufacturing the prostheses. Data concerning color and shade of the teeth of the patient are also acquired in a first step of the present methods.

Method of Making Prosthetic Assembly and Prostheses

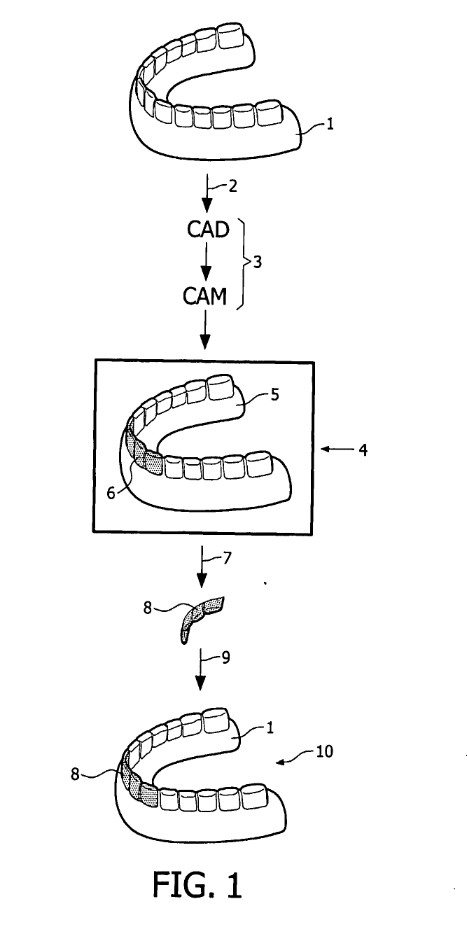

Another embodiment of the present invention is a method for making a prosthetic assembly and a prosthesis described above. An embodiment of the present method is illustrated in FIG. 1. In a first step, data concerning a patient dental arch 1 wherein teeth are to be restored are acquired 2.

Although not illustrated herein, the patient teeth to be restored can be optionally prepared in a step prior to acquiring data. For example, the enamel on the front side of the tooth or teeth to be treated can be trimmed back.

In a next step 2, data concerning a patient dental arch 1 wherein teeth are to be restored is acquired. For example, a dental impression of the patient teeth can be taken for example using impression putty and then digitally scanned in three dimensions (3D). For example, a silicone impression, a lower alginate impression and a precision bite can be taken.

In another embodiment, the practitioner may take an optical impression of the dental arch. A full-face photography of the patient and a detailed photo of the teeth to be restored can be additionally taken.

With the help of the data and using computer-aided design/computer-aided manufacturing (CAD-CAM) methods and equipment 3, a computer simulation of the teeth of the patient is generated 4. From the simulation the patient can visualize their a model of their dental dental arch 5 having simulated dental prostheses 6 thereon.

If the patient agrees 7 with his virtual improved dental arch seen in the simulation 4, a custom-made dental set 8 as described above is manufactured using CAD-CAM methods and necessary equipment. The step of fitting 9 the dental prosthesis 8 to the dental arch of the patient 1 to provide an improved dental arch 10 is described in more detail below.

The above method may be applied to the preparation of a set of custom-made prostheses as part of a prosthetic assembly, and/or to one or more individual custom-made prostheses not cojoined.

Dental Appliance

Another aspect of the present invention is a dental appliance comprising one or more prosthetic assemblies and/or one or more dental prostheses as described above disposed in a trough. According to one aspect a dental appliance comprises a trough 11 corresponding to at least part of the patient's dental arch 1 provided with custom-made prosthetic assembly 8 and/or individual dental prosthesis.

A dental appliance according to the invention is any container provided with a custom-made trough suitable for fitting an improved dental arch of a patient. The dental appliance may correspond to the full dental arch of a patient or to the partial dental arch such as for example, the front teeth of a patient. According to one embodiment of the invention, the trough precisely matches the occlusal surfaces of the dental arch, and widens to accommodate the prosthesis and any supporting substance, for example towards the region of the front teeth. The container may be formed by any material that is compatible with the body. Preferably the trough is rigid or semi-rigid. Examples of material suitable for said appliance include, but are not limited to silicon, polycarbonate, foam, polypropylene, rubberised polymer, composite, polymer and the like. In an embodiment, the dental appliance comprises transparent or translucent materials sufficient to allow light from light source to be transmitted through the dental appliance and prosthesis. This permits light-sensitive adhesive between the prosthesis and the tooth to be activated after fitting, thereby initiating the photo-chemical reaction which sets the bonding.

A trough may be formed from two or more materials with the same or different properties. For example, those parts of the trough which are required to be rigid, for example, for proper positioning of the appliance, can be rigid. Conversely, those parts of the trough contacting the prosthesis can be made from flexible material to allow cushioning effect and even distribution of pressure during fitting.

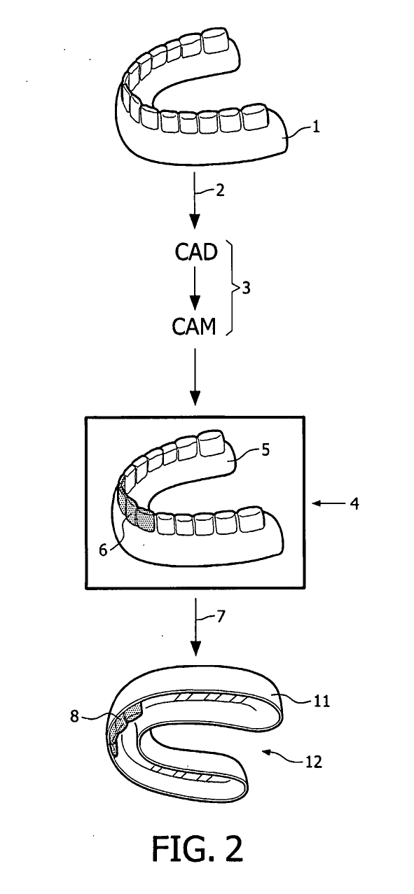

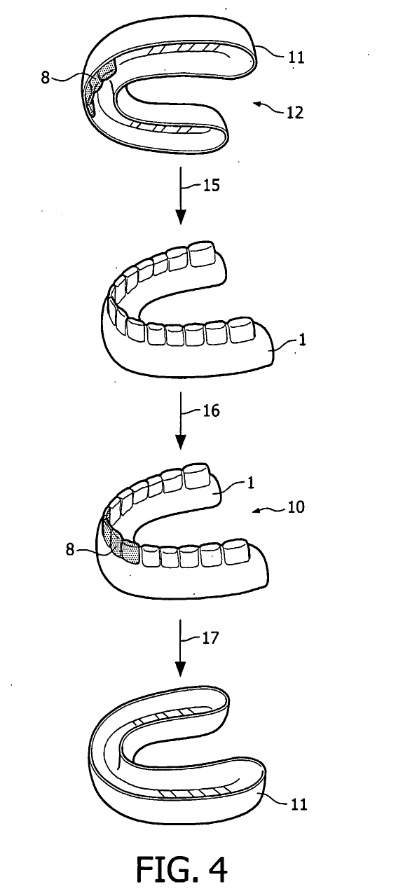

A non-limiting example of a dental appliance according to an embodiment of the present invention is shown in FIGS. 2 and 4. They show a dental appliance 12 provided with four veneers as part of a prosthetic assembly 8, said assembly 8 being disposed in a dental trough 11.

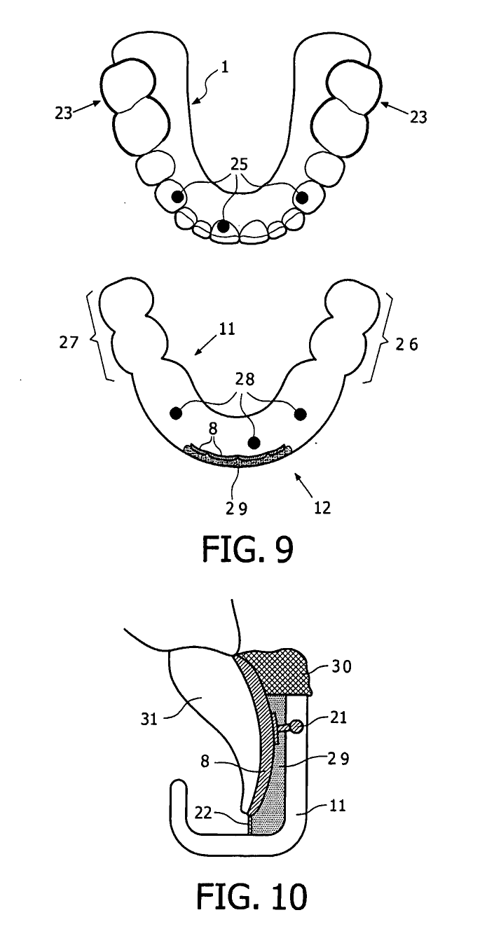

According to an aspect of the invention, the trough is provided with occlusal stops. These are parts of the trough molded in the shape of the molar or wisdom teeth. They allow the trough to engage tightly with the occlusal teeth. An example of a dental appliance provided with occlusal stop is shown in FIG. 9. The upper drawing is of a dental arch (1) of a patient in which the molars 23 are indicated. The lower drawing is of an appliance of the present invention 12 provided with a trough 11, in which occlusal stops 26,27 shaped to receive the molars 23,24 of the patient are provided. Occlusal stops accurately position and anchor the trough, so that the prosthesis 8 held in a flexible polymeric support in 29 is perfectly aligned and register with the teeth of the patient.

In additional to occlusal stops or as an alternative, a trough may be provided with one or more anchoring points. (FIGS. 9, 28). These are parts of the trough which locate co-operatively with one or more features of the teeth or dental arch, said features bring located behind the teeth i.e. the surface of the teeth facing the throat. A feature may be for example, a ridge in the base of a tooth, lip, rim, crevice, gap, a hole. The location is preferably behind the front set of teeth. An example of anchoring points is provided in FIG. 9, which upper drawing is of a dental arch 1 of a patient in which the front teeth are naturally provided with indents 25. The lower drawing is of an appliance of the present invention 12 provided with a trough 11, in which anchoring protrusions 28 positioned to engage with the indents 25 are provided. The anchoring points 28 accurately position the trough, so that the prosthesis 8 held in a flexible polymeric support in 29 is perfectly aligned and register with the teeth of the patient.

When a trough is provided with occlusal stops and anchoring points, a trough can advantageously be securely anchored and precisely located on the dental arch. A triangle of securing points is formed when the anchoring points engage with features located behind the front teeth. This prevents unwarranted movement of the trough, even when the material of the trough is not completely rigid. A combination of occlusal stops and anchoring points, therefore, means a trough may be formed of thinner, lightweight material, which is more comfortable for a patient and is also more susceptible to light permeability during bonding. An example of an appliance provided with both occlusal stops and anchoring points is provided in FIG. 9, described above.

In one embodiment, the prostheses are supported in the trough by means of a flexible polymeric substance. Such substance permits limited movement of the prostheses within the trough. It may also provide a cushioning effect in case the appliance is dropped. It may also distribute the application of pressure while applying the dental appliance to the teeth of a patient. Such substance may also attach the dental appliance to the trough by virtue of an adhesive property and/or by anchoring via the optional positioning points of the prostheses. Examples of suitable supporting materials include, but are not limited to hot-melt adhesive, silicone rubber, or other flexible polymeric material.

FIG. 10 shows an example of a dental appliance in which the prosthetic assembly (8) is applied to the teeth 31, and is supported in the trough 11 by a flexible polymeric support 29. Said support attaches to the prosthesis via the positioning points (21 and 22). FIG. 10 also depicts a releasing strip 30, which can be removed from the appliance during fitting to enable a better view of gingival edge of the teeth.

In one embodiment, the prostheses are attached to the dental appliance using suitable non-permanent bonding means, such as an adhesive (e.g. a hot-melt adhesive), or a rubber polymer which grips the positioning means. In an embodiment, when the exterior surface of tooth prosthesis is quite smooth and flat, a primer coating can first be applied to the exterior surface of the veneer before hot melted adhesive is applied. The purpose of the primer coating is to improve the bond between the dental appliance and the prosthesis provided therein. In another embodiment, the adhesive employed is solid at room temperature, although slightly resilient, but becomes flowable when heated.

According to one embodiment of the invention, a supporting substance or non-permanent bonding means is disposed towards the biting edge of the prostheses. It may support the prostheses by attaching to a positioning means located on the biting edge of the prosthesis. Where a supporting substance or non-permanent bonding means is disposed on the exposed surface of the prostheses, it is preferably translucent to allow light from light source to be transmitted through the dental appliance and prostheses. This permits light-sensitive adhesive between the prostheses and the tooth to be activated after fitting, thereby initiating the photo-chemical reaction which sets the bonding.

In a further aspect of the invention, the dental appliance is configured such that the trough supports and protects the biting edge of the prostheses, while the gingival edge is not protected by the trough. By leaving the gingival edge exposed, the technician can clearly confirm the alignment of the prostheses with the gums and teeth during fitting, without obstruction by the trough. It is a further aspect of the invention that such a trough is provided with a release strip which supports and protects the exposed part of the prostheses during transport and fitting of the appliance. Said release strip may be removed during fitting to provide a clear view of the alignment. The release strip may be made from any suitable material having the properties to cushion and protect the exposed portion of the prosthesis. The release strip may be manufactured from a transparent or opaque material although this is not a requirement in view that it is removed during fitting. Examples of suitable release strip materials include, for example, polymeric rubber and silicone rubber.

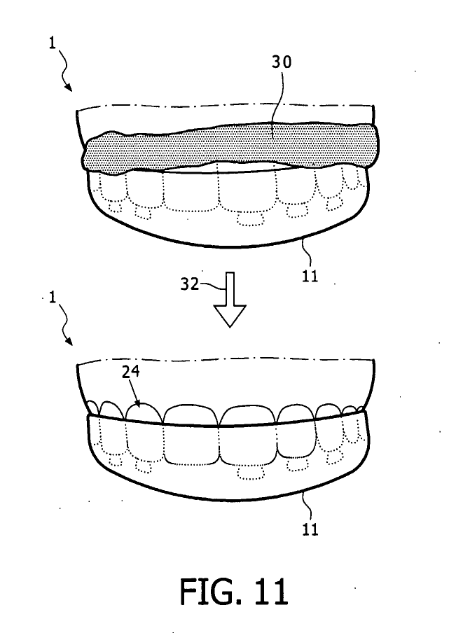

FIG. 11 depicts an appliance of the invention fitted to the dental arch 1 of a patient in which the trough 11 is provided with a releasing strip, 30, which at least partially supports and protects the exposed part of the prostheses during transport and fitting of the appliance. Upon removal 32, of the strip 30, the gingival edge is exposed 24, allowing un-obscured alignment of the prosthetic assembly with the teeth.

Method of Manufacture Appliance

An embodiment of a method for a manufacture of a dental appliance is illustrated in FIG. 2. Steps 2 to 7 for preparing a prosthetic assembly and/or prostheses are already described above.

Once the patient agrees 7 with his virtual improved dental arch 4, a custom-made dental appliance 12 is manufactured using CAD-CAM methods and equipments. The manufactured dental appliance 12 comprises a trough 11 corresponding to a model of the patient's improved dental arch 4 provided with custom-made prosthesis provided in a prosthetic assembly 8.

The present invention thereby also provides a dental appliance 12 comprising a U shaped trough 11 corresponding to the patient's improved dental arch and provided therein with one or more dental prostheses as part of an assembly 8, and/or one or more prostheses not cojoined. Said dental appliance can be obtainable according a method of the invention.

Non-limiting examples of CAD/CAM methods and equipment suitable for use in the present invention are described in U.S. Pat. Nos. 4,937,928, 5,910,273, 4,575,805, and 4,663,720 and are hereby incorporated by reference. Examples of suitable commercially available CAD/CAM systems include but are not limited to the Cerec™ system available from Sirona™ USA, Charlotte, N.C., and the Pro50™ system available from Cynovad™, Quebec City, Canada, Paradigm M2 block for CEREC from 3M.

The present invention further provides a prosthetic assembly comprising one or more prostheses provided thereon with a positioning pin.

Suitable material for manufacturing the dental prostheses and appliance are mentioned above

Method of Fitting

The prosthetic assembly of the present invention can be fitted to the teeth of the patient in the absence a trough. It may also be fitted as part of a trough. In the latter case, the trough may additionally be provided with one or more individual prostheses, not cojoined.

Prior to fitting, it is an aspect of the invention that the inner surface of the prostheses can be sand-blasted. Then a bond enhancer such as a silane can be applied on the inner surface and let set for 1 minute for example and dried. Bonding can then be applied to the treated prostheses and said bonding can be cured with light.

In an embodiment, the prostheses can be supplied with suitable bonding means. In another embodiment, the teeth can be provided with suitable bonding means.

For example, in a preliminary step prior to fitting the prosthetic assembly or appliance in the patient's mouth, the outer surface of the teeth to be treated can be prepared and cleaned. For example, the enamel on the front side of the tooth or teeth to be treated can be trimmed back. For example the enamel can be prepared and roughened for example with a diamond burr. In a next step the enamel surface of the tooth to be restored can be etched with a mild etching gel. The etching can be for example performed with 32 to 37% phosphoric acid for 30 seconds. Optionally a bond enhancer such as silane can be applied to the teeth to be restored and then dried.

Bonding can then be applied to the teeth to be restored. Before that step, small strips can be positioned between the teeth. After curing the bonding strips can be removed.

Fitting Prosthetic Assembly without Trough

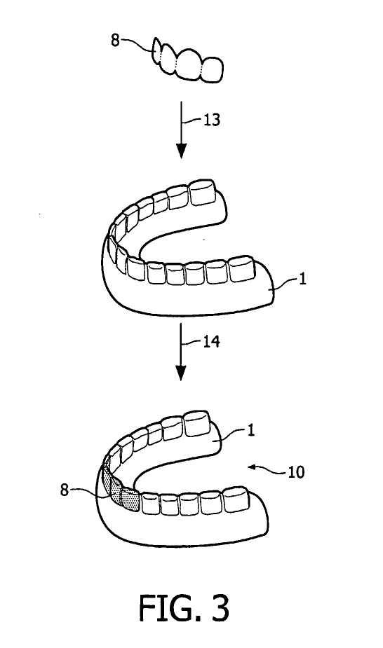

After the teeth have been prepared and bonding applied, the prosthetic assembly can be applied. In an embodiment, the next steps of the method are illustrated on FIG. 3. The custom-made prosthetic assembly 8 can then be applied 13 to the patient dental arch 1, whereby said prosthetic assembly 8 is simultaneously positioned and fitted in perfect registry with the teeth to be restored. The assembly is custom-made according to the model of a particular improved dental arch 4. The shape of the teeth and curvature of the dental arch permit precise and accurate location of the prosthetic assembly. The prosthetic assembly 8 can, therefore, be precisely matched and positioned on the patient's teeth in conformity with the virtual simulation of the patient improved dental arch 4 generated in the methods according to the invention.

The prosthetic assembly is bonded 14 to the teeth of the patient whereby the improved dental arch 10 is obtained. The bonding step 14 may be performed using conventional bonding techniques or mechanical anchoring techniques. A thin layer of light curing composite material can be applied on the inner surface of the prostheses.

Fitting Prosthetic Assembly and/or Prostheses in Trough

Where the prosthetic assembly 8 and/or individual prostheses are incorporated into a trough 11, the dental appliance 12 is custom-made according to the model of a particular improved dental arch 4. The custom-fitting appliance also named herein positioning tray 12 provides a perfect fit which allows one or more prosthetic assemblies 8 and/or prostheses provided therein to be precisely positioned and placed on the patient's teeth in conformity with the virtual simulation of the patient improved dental arch 4 generated in the methods according to the invention. The dental appliance covers the occlusal part of the posterior teeth for stabilization during placement and positioning.

In an embodiment, the next steps of the method are illustrated on FIG. 4. The custom-made dental appliance 12 comprising a trough 11 provided with custom-made prosthetic assembly 8 and/or prostheses can then applied 15 to the patient dental arch 1, whereby said prosthetic assembly 8 and/or prostheses are simultaneously positioned and fitted in perfect registry with the teeth to be restored. In a next step of said process, the prosthetic assembly 8 and/or prostheses are bonded 16 to the teeth of the patient whereby the improved dental arch 10 is obtained. The bonding step 16 may be performed using conventional bonding techniques or mechanical anchoring techniques. A thin layer of light curing composite material can be applied on the inner surface of the prostheses. The dental appliances can then be gently positioned over the teeth. The occlusal stops will help the perfect positioning and registry of the dental appliance.

A fast curing light such as UV light can be applied to the prosthetic assembly and/or prostheses to cure the bonding agent between the prostheses and the teeth. If necessary, the patient may then bite on the flexible appliance to hold the dental appliance in place while the prostheses are bonded to the teeth.

When the bonding operation is complete, the dental appliance can be removed 17 from the patient mouth and the trough 11 of the dental appliance can be disposed of.

When two or more dental prostheses are provided in a prosthetic assembly, the teeth can be separated with a mini saw and the incisal part of the teeth can be adapted with a diamond burr and/or the inter proximal angles can be widened. After removing any unnecessary material, a curing light can be applied for example for 3 seconds.

The dental appliances of the present invention increase the efficiency of the operation and minimize the risk of dental prosthesis such as a veneer being dropped. By using the dental appliance of the present invention, the operator can conveniently and simultaneously place a series of veneers on a patient's teeth.

Whitening

The method according to the present invention may optionally comprise a prior whitening treatment of a patient's teeth using any bleaching techniques. In an embodiment, the bleaching techniques comprises using a U shaped dental trough wherein is provided a bleaching agent. The prosthetic assembly or prostheses such as the veneers used in the present method are then designed according to the colors of the patient's teeth.

A “bleaching agent” or “bleaching compound” is any agent or compound that whitens the teeth. Suitable bleaching agents can be powders, viscous liquids or gels.

Examples of suitable bleaching compounds include an oxygen radical generating agent such as metal ion free peroxides, organic peroxides, metal ion containing peroxides, metal chlorites, perborates, percarbonates, peroxyacids and combinations thereof. Specific, non-limiting examples of bleaching agents suitable for use with the invention are redox agents such as monopersulfate, Oxone, ammonium persulfate, potassium persulfate, potassium monopersulfate, potassium peroxymonosulfate, potassium bisulfate, potassium sulfate, and potassium peroxidisulfate. Additional specific, non-limiting examples of bleaching agents suitable for use with the device of the invention are the peroxide class of bleaching agents such as hydrogen peroxide, calcium peroxide, carbamide peroxide, urea peroxide, sodium percarbonate, sodium perborate, calcium hydroxide, calcium chlorite, barium chlorite, magnesium chlorite, lithium chlorite, potassium chlorate, hypochlorite, chlorine dioxide, magnesium carbonate and perhydrol urea and mixtures thereof. In an embodiment the bleaching agent is hydrogen peroxide. These compounds can be provided in gel matrices of differing concentrations.

Advantages

The present invention provides the advantage of positioning and fitting simultaneously one or more dental prostheses on a patient's teeth. By using the present methods and device it is possible to position and hold one or more dental prosthesis in proper registry with the teeth during the bonding process. The dental appliance of the present invention is easily operable with a single hand and is produced in a simple and inherently low-cost design.

Temporary Denture

The present invention further encompasses a set of temporary denture for surrounding the patient's own teeth and gums. Said temporary denture is comprised of a flexible trough. The denture includes a gum portion and a tooth portion shaped and dimensioned to cover one or more of the upper or lower teeth of the patient, preferably the denture according to the invention has golden proportions. The tooth portion preferably simulates the appearance of natural teeth, with respect to color, size and shape.

The temporary denture is made of a nontoxic, nonirritating, tasteless, odorless, flexible, resilient, easily cleaned and chemically stable material. In use, the device can be held in place by the springiness of the material. The temporary denture, which can be custom-fitted by the user, is made in several sizes to accommodate the range of upper or lower jaw sizes found in patient. The temporary denture can be designed so as to cover one or more teeth of the patient's upper or lower jaw. In one embodiment said temporary denture will be designed so as to cover the front teeth of a patient, for example from 2 to 6 front teeth. In another embodiment said denture will be designed to cover the whole dental arch of a patient. Examples of material suitable for said temporary denture include, but are not limited to silicon, polycarbonate, foam, polypropylene, rubberized polymer, composite, polymer and the like.

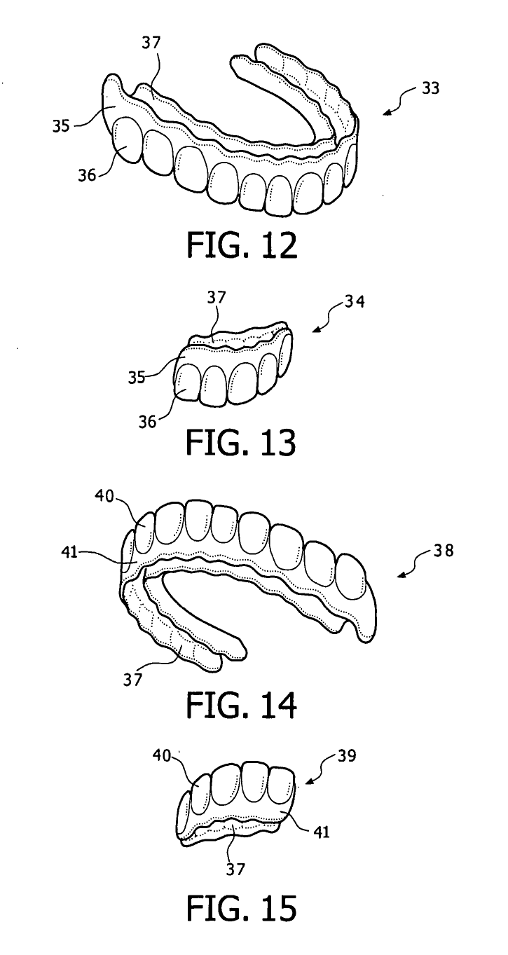

FIG. 12 represents a schematic perspective view of a temporary denture 33 for surrounding a patient's upper teeth and gums according to an embodiment of the present invention. Said temporary denture 33 is comprised of a flexible trough 37. The denture includes a gum portion 35 and a tooth portion 36 shaped and dimensioned to cover the patient's upper dental arch.

FIG. 13 represents a schematic perspective view of a temporary denture 34 for surrounding a patient's upper front teeth and gums according to an embodiment of the present invention. Said temporary denture 34 is comprised of a flexible trough 21. The denture includes a gum portion 35 and a tooth portion 36 shaped and dimensioned to cover the patient's upper front teeth.

FIG. 14 represents a schematic perspective view of a temporary denture 38 for surrounding a patient's lower teeth and gums according to an embodiment of the present invention. Said temporary denture 38 is comprised of a flexible trough 37. The denture includes a gum portion 41 and a tooth portion 40 shaped and dimensioned to cover the patient's lower dental arch.

FIG. 15 represents a schematic perspective view of a temporary denture 39 for surrounding a patient's lower front teeth and gums according to an embodiment of the present invention. Said temporary denture 39 is comprised of a flexible trough 37. The denture includes a gum portion 41 and a tooth portion 40 shaped and dimensioned to cover the patient's lower front teeth.

The present temporary denture can be proposed to the patient by the practitioner to demonstrate and illustrates the results which can be obtained with the dental prosthesis of the dental appliance according to the invention. Said denture can be worn for relatively short periods of time to longer period of time depending on the patient and/or practitioner needs and desires, for example from 2 min to 3 of 4 days.

If the patient is satisfied with the result achieved by the temporary denture, he can then order a dental appliance according to the present invention comprising one or more dental prostheses.

The present invention further encompasses a dental kit comprising a set of temporary denture according to the invention, provided in several sizes and shapes.

1-30. (canceled)

31. Prosthetic assembly comprising two or more dental prostheses, wherein said prostheses are adjacently connected, said connection comprising one or more weakened points, and the assembly is pre-shaped to fit the teeth of a subject.

32. Prosthetic assembly according to claim 31, wherein said connection is of the same material as the prostheses.

33. Dental appliance comprising one or more prosthetic assemblies according to claim 31, and a trough wherein said trough corresponds to an improved dental arch.

34. Dental appliance according to claim 33, further comprising, one or more custom made individual prostheses.

35. Dental appliance according to claim 33, wherein said trough comprises one or more occlusal stops.

36. Dental appliance according to claim 33, wherein said trough comprises one or more anchoring points.

37. Dental appliance according to claim 36, wherein said anchoring points engage with features located behind the front teeth.

38. Dental appliance according to claim 33, wherein one or more dental prosthesis is provided with a positioning means.

39. Dental appliance according to claim 38, wherein said positioning means is an addition to a veneer and formed of the same material as the veneer.

40. Dental appliance according to claim 33 further comprising supporting substance disposed one the labile face or biting edge of a veneer.

41. Dental appliance according to claim 40, wherein a supporting substance is silicone rubber or hot-melt adhesive.

42. Dental appliance according to claim 33, wherein the trough is configured to leave a gingival edge exposed upon fitting.

43. Dental appliance according to claim 42, wherein the trough is provided with a strip of releasable material which protects and supports the exposed part of the prostheses.

44. Dental appliance or prosthetic assembly according to claim 31, wherein said dental prostheses are selected from the group comprising veneers, facings, facets and the like.

45. Method for manufacturing a dental appliance suitable for fitting one or more dental prostheses on a patient's teeth comprising the steps of:
(a) obtaining data of a patient dental arch,
(b) using said data, generating a computer simulation of an improved patient dental arch, wherein said patient dental arch is improved by incorporation thereon of one or more virtual dental prostheses, and
(c) manufacturing a dental appliance corresponding to the improved patient dental arch, wherein said dental appliance comprises a trough provided with two or more prostheses that are adjacently connected, said connection comprising one or more weakened points, and the assembly is pre-shaped to fit the teeth of a subject.

46. Method according to claim 45, wherein the data obtained from the patient dental arch are acquired by making a dental impression of the patient teeth and digitally scanning in 3D said dental impression.

47. Method according to claim 45, wherein the data obtained from the patient dental arch are acquired by photographing the patient teeth.

48. Method according to claim 45, wherein the data obtained from the patient dental arch are acquired by digitally scanning the patient teeth.

49. Method according to claim 45, wherein said dental prostheses are provided with dental bonding means.

50. Method according to claim 45, wherein steps (b) and (c) are performed using computer assisted design and manufacturing methods and equipments.

51. Method according to claim 45, wherein said dental prostheses are selected from the group comprising veneers, facings, facets and the like.

52. Dental appliance according to claim 45, wherein said dental appliance is transparent to light.
